(19) United States
(12) Patent Application Publication
(10) Pub. No.: US 2017/0344364 A1
(43) Pub. Date: Nov. 30, 2017

(54) SYSTEM AND METHOD FOR DATA COMPATIBILITY ACROSS HETEROGENEOUS MACHINE ARCHITECTURES

(71) Applicant: Honeywell International Inc., Morristown, NJ (US)

(72) Inventors: Elliott Rachlin, Scottsdale, AZ (US); Richard Parviz Nabavi, Mayfield (GB); Simon David Marsden, Horam (GB)

(21) Appl. No.: 15/164,724

(22) Filed: May 25, 2016

(51) Int. Cl. G06F 9/44; G06F 9/30; G06F 7/50

(52) U.S. Cl. CPC G06F 8/71; G06F 7/50; G06F 9/30101

(57) ABSTRACT

A method includes loading a data element from at least one memory into at least one internal register. The method also includes converting the data element from a network standardized format to a device native format. The method further includes performing an operation on the data value. The method also includes de-converting the data element from the device native format to the network standardized format. In addition, the method includes storing the data element in the at least one memory.

### TECHNICAL FIELD

This disclosure relates generally to techniques for obtaining data compatibility across machine architectures. More specifically, this disclosure relates to a system and method for data compatibility across heterogeneous machine architectures.

### BACKGROUND

The term “endian” refers to a convention used to store and interpret two or more bytes making up a data word or message when stored in computer memory. Each byte of data in memory typically has its own address. When reading or writing a data word containing multiple bytes, the order of the bytes stored in memory determines the interpretation of the data word.

Big-endian systems store the most significant byte of a data word in the smallest address and the least significant byte of the data word in the largest address. In contrast, little-endian systems store the least significant byte of a data word in the smallest address and the most significant byte of the data word in the largest address. When data is moved from a big-endian device or system to a little-endian device or system (or vice versa), the data needs to be converted to the appropriate “endianness,” or the receiving device or system needs to account for the difference.

### SUMMARY

This disclosure provides a system and method for data compatibility across heterogeneous machine architectures.

In a first embodiment, a method includes loading a data element from at least one memory into at least one internal register. The method also includes converting the data element from a network standardized format to a device native format. The method further includes performing an operation on the data value. The method also includes de-converting the data element from the device native format to the network standardized format. In addition, the method includes storing the data element in the at least one memory.

In a second embodiment, an apparatus includes at least one memory and at least one processor. The at least one memory is configured to store a data element. The at least one processing device is configured to load the data element from the at least one memory into at least one internal register. The at least one processing device is also configured to convert the data element from a network standardized format to a device native format. The at least one processing device is further configured to perform an operation on the data value. The at least one processing device is also configured to de-convert the data element from the device native format to the network standardized format. In addition, the at least one processing device is configured to store the data element in the at least one memory.

In a third embodiment, a non-transitory computer readable medium contains instructions that, when executed by at least one processing device, cause the at least one processing device to load a data element from at least one memory into at least one internal register. The medium also contains instructions that, when executed by the at least one processing device, cause the at least one processing device to convert the data element from a network standardized format to a device native format. The medium further contains instructions that, when executed by the at least one processing device, cause the at least one processing device to perform an operation on the data value. The medium also contains instructions that, when executed by the at least one processing device, cause the at least one processing device to de-convert the data element from the device native format to the network standardized format. In addition, the medium contains instructions that, when executed by the at least one processing device, cause the at least one processing device to store the data element in the at least one memory.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example heterogeneous system according to this disclosure;

FIG. 2 illustrates an example system for data compatibility across heterogeneous machine architectures according to this disclosure;

FIG. 3 illustrates an example method for data compatibility across heterogeneous machine architectures in a heterogeneous system according to this disclosure; and

FIG. 4 illustrates an example device for data compatibility across heterogeneous machine architectures according to this disclosure.

### DETAILED DESCRIPTION

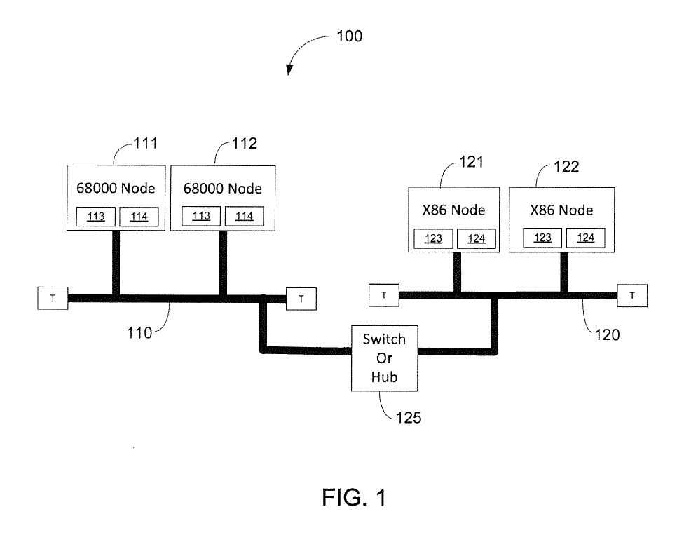

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In modern computer systems, multiple computers or other devices can be connected together by one or more communication networks that enable those devices to exchange and share data. In a system or network of computers or other devices, there may be a variety of devices that are produced by different manufacturers or that operate using different operating systems. For example, some devices may represent general-purpose computers that include x86 processors by INTEL. Other devices may represent controllers in an industrial process control and automation system, such as those used in an industrial manufacturing or processing system (like a refinery, chemical plant, or factory). Such controllers may include 68000-family processors by MOTOROLA. When devices of different types in a mixed network exchange data, the data generally needs to be arranged into a form that is compatible with both devices.

As one example, in some systems, certain devices may be big-endian, while other devices might be little-endian. When data messages having complex data structures are shared between devices of differing endian architectures, those devices may be unable to directly share data due to differences in byte ordering of numerical values. For example, a message can have potentially hundreds or thousands of integers or floating-point values. Such a message may be stored in big-endian format at a transmitter, while an intended receiver may be configured to interpret values stored in little-endian format (or vice versa). As used in this document, a “message” generally refers to any type of data arranged in a sequence and does not necessarily refer to any particular record or structure.

As another example, in some systems, certain devices may use IEEE 754 standard floating point format for representation of floating point values, while other devices may use older, pre-standard representations of floating point values. As with the big-endian/little-endian difference, a difference in floating point representation between devices in a system may result in difficulty in sharing data or data messages between the different devices.

Some systems provide a solution to differing endian architectures by taking a data message, divided it into components, examining each component for its current endian format, and converting each component that is not currently in the correct endian format into the correct format. Although this process works well for messages where a template of the exact message layout is known, a message template may not be available in some circumstances. Also, for some complex data messages, the template may be complicated and difficult to maintain. An alternative approach places the burden of conversion on the programmer, who has to identify each use of data in the program and modify the program to handle data that is not in the correct endian format. This approach may require substantial engineering effort and is intrinsically error-prone because it relies on the programmer correctly identifying every endian-dependent assumption in the program.

To address these and other issues, embodiments of this disclosure provide a process for data compatibility across heterogeneous machine architectures, regardless of the data structure. The process thereby facilitates sharing data structures among devices having differing endian architectures, differing floating point representations, or any other similar differences.

FIG. 1 illustrates an example heterogeneous system 100 according to this disclosure. As shown in FIG. 1, the heterogeneous system 100 includes a first network 110 and a second network 120 that are coupled to a switch or hub 125. The network 110 includes a number of nodes, including nodes 111-112. Similarly, the network 120 includes a number of nodes, including nodes 121-122.

In this example embodiment, the heterogeneous system 100 can represent all or a portion of an industrial process control and automation system. For example, the nodes 111-112 can include one or more industrial process controllers configured to control process elements in a process or production system that may perform any of a wide variety of functions. As a particular example, the nodes 111-112 could be configured to provide control signals to process elements or equipment used to manufacture chemical, pharmaceutical, paper, or petrochemical products. Each node 111-112 includes any suitable structure for performing one or more functions in a process or production system. The nodes 111-112 could, for example, include one or more processing devices 113 and one or more memories 114 storing instructions and data used, collected, or generated by the processing device(s) 113. As particular examples, the processing devices 113 could include processors in the MOTOROLA 68000 processor family.

As another example, the nodes 121-122 can include one or more operator stations configured for user access and control of the process control and automation system. Each of the nodes 121-122 could, for example, include one or more processing devices 123 and one or more memories 124 storing instructions and data used, collected, or generated by the processing device(s) 123, such as software executed by the nodes 121-122. In particular embodiments, the nodes 121-122 could represent personal computers executing a MICROSOFT WINDOWS operating system, and the processing devices 123 could include processors in the INTEL x86 processor family.

The nodes 111-112 and 121-122 are coupled to each other and to other components of the system 100 through the networks 110-120. Each network 110-120 facilitates communication between various components in the system 100. Each network 110-120 represents any network or combination of networks facilitating communication between components in the system 100. For example, the network 110 could represent a controller network in a process control system, such as a coaxial cable network or Ethernet network. As another example, the network 120 could represent an Ethernet network.

In these embodiments, the nodes 111-112, 121-122 may have different machine architectures and may support different data structures or data formats. For example, the nodes 111-112 may use a big-endian format for data storage, while the nodes 121-122 may use a little-endian format for data storage. Likewise, certain ones of the nodes 111-112, 121-122 may use IEEE 754 standard floating point representation, while other ones of the nodes 111-112, 121-122 may use non-standard floating point representation. Thus, data sent between the network 110 and the network 120 (such as instructions or data transmitted from the node 121 to the node 111 or operational status data transmitted from the node 112 to the node 122) may need to be processed differently, depending on the machine architecture of the processing node.

To achieve this, the system 100 uses the notion of a canonical representation of multi-byte data across an entire network of data sharers, regardless of the machine architecture of the member devices. In the system 100, a network standard format (also referred to as a canonical format) is selected for all shared data. For example, the canonical format may be big-endian and standard floating point. As another example, the canonical format may be little-endian and standard floating point. Once the canonical format is determined, all data transmitted and received between the nodes 111-112, 121-122 is maintained in the canonical format, regardless of the architecture of the individual network nodes. A network device (such as one of the nodes 111-112, 121-122) that natively operates using a format different from the canonical format receives and transmits data to other devices using the canonical format. However, internal calculations and processing in such a device are performed in the native non-canonical format, so a translation of data from the canonical format to the native format (or vice versa) is performed. The necessity of performing the data conversion can be determined by each individual device, which inherently knows if it follows or differs from the network canonical data format.

As an example, assume that the canonical format for the system 100 is big-endian and IEEE 754 standard floating point representation, while the native format for the node 121 is little-endian and non-standard floating point representation. When the node 121 performs an arithmetic operation on data, the node 121 moves the data from its memory into its internal arithmetic registers as usual. In addition, the node 121 performs a data conversion from big-endian/standard floating point to little-endian/non-standard floating point. The node 121 also performs a reverse conversion or “de-conversion” (from little-endian/non-standard floating point to big-endian/standard floating point) when moving data from the arithmetic registers back into memory. Thus, data in memory is kept in canonical format, even though it may be in non-canonical format in registers for the purposes of performing arithmetic operations. With this invariant of data representation, incoming data from other network nodes is in the network canonical format, and the node 121 is able to properly interpret that data. Thus, the node 121 may remain uninterested in the specific native format of the original sender of that data.

In some embodiments, the translation of data between canonical format and native format is made possible using a translation routine that modifies computer instructions to be able to tolerate having the “wrong” format for data in the device's memory. For example, a software translation routine can modify ordinary machine assembly code to provide for the swapping of data from the canonical format to the native format for the particular device as machine operations are executed. For network devices that inherently prefer the canonical format (such as when the node 112 is big-endian/standard floating point), the data representation translation is NULL (although the device may perform other translations for other purposes during this translation phase of processing). Further details regarding the translation are provided below.

Although FIG. 1 illustrates one example of a heterogeneous system 100, various changes may be made to FIG. 1. For example, components could be added, omitted, combined, or placed in any other configuration according to particular needs. Also, while described as representing all or a portion of a process control and automation system, the heterogeneous system 100 could be used in any other manner. Further, the specific types of processors (68000 and x86) shown in FIG. 1 are examples only, and any other or additional type(s) of processor(s) could be used in each node. In addition, FIG. 1 illustrates one operational environment in which methods for data compatibility across heterogeneous machine architectures can be used. The data compatibility methods described here could be used in any other device or system.

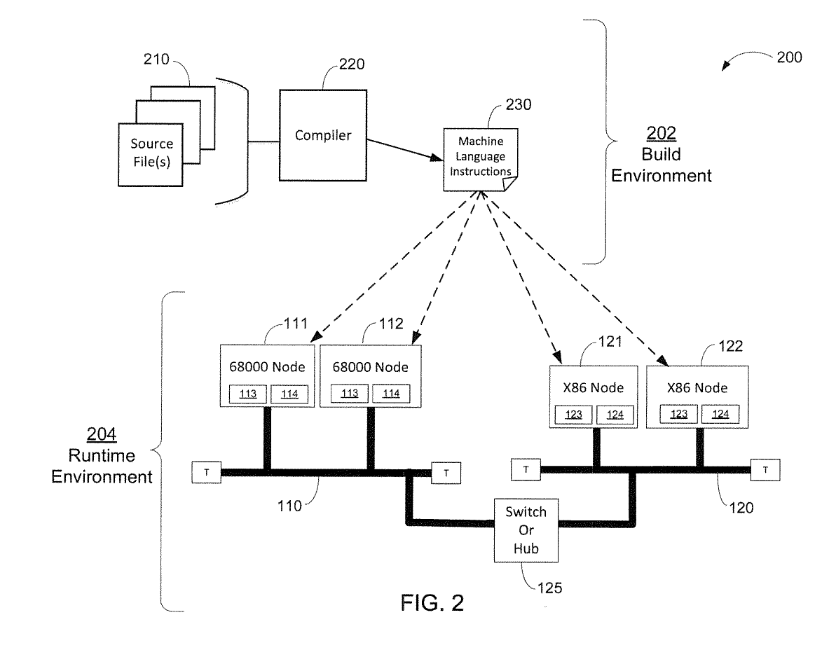

FIG. 2 illustrates an example system 200 for data compatibility across heterogeneous machine architectures according to this disclosure. As shown in FIG. 2, the system 200 includes a build environment 202 and a runtime environment 204. The runtime environment 204 can include or represent all or a portion of the components of the system 100 shown in FIG. 1 and described above.

In the build environment 202, one or more operators (such as a system engineer, programmer, or data administrator) develop and maintain software used by the nodes 111-112, 121-122 during execution in the runtime environment 204. For example, the operators can develop and maintain source files 210 that are written in a high-level programming language, such as C or some version thereof. A software compiler 220 compiles the source files 210 into machine assembly language instructions 230 that are executable by one or more of the nodes 111-112, 121-122 in the runtime environment 204. Typically, the executable instructions 230 are loaded into a memory 114, 124 of at least one node 111-112, 121-122 for execution by the processing device(s) 113, 123 of the node(s).

The nodes 111-112, 121-122 in the runtime environment 204 use the machine assembly language instructions 230 that have been prepared in the build environment 202. For example, each node 111-112, 121-122 can execute the machine assembly language instructions 230 to detect and receive data messages transmitted from other nodes 111-112, 121-122 and perform various operations using the data in the data messages.

In the system 200, the “high order” structure of each data message is ignored. That is, the system 200 does not pay attention to the structural format of each data message (such as how many data fields are present and what each data field represents). Instead, the system 200 is concerned about the fundamental machine formats of data, including floating point numbers, integers (such as eight-byte integers, four-byte integers, two-byte integers, and the like), and character strings. The system 200 is also concerned about the native format of each node 111-112, 121-122. Depending on the native format of the node 111-112, 121-122 for which the machine assembly language instructions 230 are created, the compiler 220 adds appropriate data conversion and de-conversion operations to the executable instructions 230.

To better illustrate the operation of the system 200, a comparison with a typical processing system is helpful. Assume that a current operation to be performed by a computing device is to numerically add a value of “1” to a value in a data field. In a typical processing system, the computing device would execute machine assembly language instructions to load the data field value from device memory into an internal register, increment the value in the register by one, and then store the value back into device memory. Such instructions (such as Load, Add, and Store) can be generated from source code during a compilation operation.

Now, the same example is considered in the system 200. Again, assume that a current operation is to increment a value in a data field by “1”. Also assume that the canonical format of the system 200 is big-endian/standard floating point, the node 122 is the computing device performing the operation, and the native format for the node 122 is little-endian/standard floating point. If a four-byte integer data value is to be incremented by the node 122, the node 122 reads the integer into the data register and performs a byte swap, which is the conversion from canonical format (big-endian) to native format (little-endian). The node 122 also adds one to the value in the register using little-endian format, performs another byte swap to convert back to big-endian, and stores the data in memory. Thus, the instructions performed by the node 122 are Load, Convert, Add, De-Convert, and Store.

In contrast to a typical computing device, the node 122 performs Convert and De-Convert instructions that are part of the machine assembly language instructions 230 generated by the compiler 220. The Convert and De-Convert instructions can be included in the machine assembly language instructions 230 as needed when the source files 210 are compiled. This can be part of the compilation routine performed by the compiler 220. In other words, at the time of compilation, the compiler 220 adds the Convert and De-Convert instructions to the machine assembly language instructions 230.

In some embodiments, the compiler 220 knows or can determine the native format of the node 122. For example, the native format for each node 111-112, 121-122 can be stored in a data table or other structure(s), and the compiler 220 can read the correct native format for a particular node when the compiler 220 compiles code for the particular node. In other embodiments, an operator (such as a programmer) instructs the compiler 220 of the native format. For example, the operator may instruct the complier 220 to compile source code for a machine that is little-endian and standard floating point or some other particular type of machine. The compiler 220 adds the appropriate Convert and De-Convert instructions when the machine assembly language instructions 230 are generated. In some cases, these instructions may be null if conversion is not needed, such as when a node already processes data using the network canonical format.

In some embodiments, the canonical format is big-endian and standard floating point, little-endian and standard floating point, big-endian and non-standard floating point, or little-endian and non-standard floating point. Thus, depending on the native format of the computing device, the Convert instructions may include a “Convert from big-endian to little-endian” operation (or vice versa), a “Convert from standard floating point to non-standard floating point” operation (or vice versa), or both. The De-Convert instructions denote the inverse of the Convert instructions. Also, canonical format is not limited only to endian formats and floating point formats. Other data-related characteristics are possible, and conversion and de-conversion can include one, some, or all of the data-related characteristics depending on the native format of the particular device.

Although an example of incrementing a value by one has been described above, the Convert and De-Convert instructions can be added for any fundamental data operation (including add, subtract, load, and store) and for any data value having a fundamental machine format of data (including floating point numbers, integers, and character strings). Using the system 200, data in memory and data transmitted across the networks 110-120 can remain in canonical format. Thus, instead of being required to know the format of many message structures, the system 200 only needs to know the format for the fundamental machine formats of data. In some embodiments, a programmer does not even need to know those. Instead, the compiler 220 can automatically identify an executing device and can add Convert and De-Convert instructions during compilation as needed.

Although FIG. 2 illustrates one example of a system 200 for data compatibility across heterogeneous machine architectures, various changes may be made to FIG. 2. For example, various components in FIG. 2 could be combined, further subdivided, or omitted and additional components could be added according to particular needs. Also, system build environments and runtime environments can come in a wide variety of configurations, and FIG. 2 does not limit this disclosure to any particular configuration.

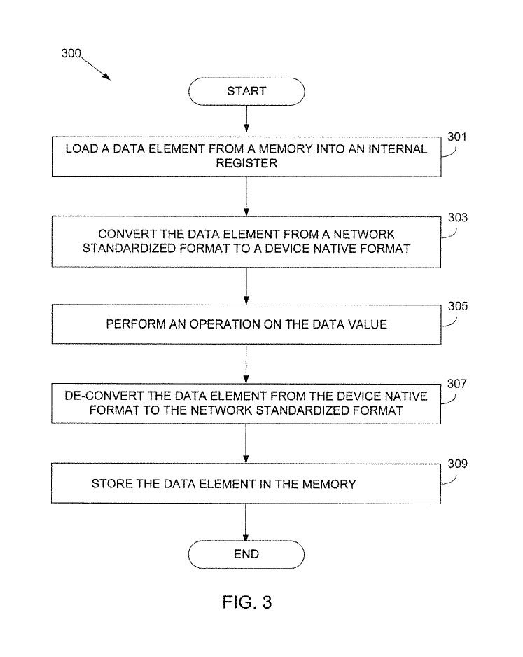

FIG. 3 illustrates an example method 300 for data compatibility across heterogeneous machine architectures in a heterogeneous system according to this disclosure. For ease of explanation, the method 300 is described as being performed using the system 200 of FIG. 2. However, the method 300 could be used with any suitable device or system.

At step 301, the system 200 loads a data element from a memory into an internal register. This may include, for example, a node 111-112, 121-122 loading a data element of a data message from an internal memory into an internal register. The data message may have been received from another node 111-112, 121-122 across one or more of the networks 110-120.

At step 303, the system 200 converts the data element from a network standardized format to a device native format. This may include, for example, the node 111-112, 121-122 performing an endian conversion, a floating point format conversion, or both. In particular, this may include the node 111-112, 121-122 converting the data element from big-endian (the network standardized or canonical format) to little-endian (the device native format).

At step 305, the system 200 performs an operation on the data value. This may include, for example, the node 111-112, 121-122 performing the operation on the data value in the internal register. In some embodiments, the operation is a fundamental mathematical operation, such as increment by one.

At step 307, the system 200 de-converts the data element from the device native format to the network standardized format. This may include, for example, the node 111-112, 121-122 performing an endian de-conversion, a floating point format de-conversion, or both. In particular, this may include the node 111-112, 121-122 de-converting the data element from little-endian to big-endian.

At step 309, the system 200 stores the data element in the memory. This may include, for example, the node 111-112, 121-122 storing the data element from the internal register to the internal memory.

In some embodiments, the instructions to perform the converting and de-converting operations are added by the compiler 220 to machine assembly language instructions 230 during a compilation of source code 210 of a higher-level programming language.

Although FIG. 3 illustrates one example of a method 300 for data compatibility across heterogeneous machine architectures, various changes may be made to FIG. 3. For example, while shown as a series of steps, various steps shown in FIG. 3 could overlap, occur in parallel, occur in a different order, or occur multiple times. Moreover, some steps could be combined or removed and additional steps could be added according to particular needs. In addition, while the method 300 is described with respect to the system 200, which was described with respect to an industrial process control and automation system, the method 300 may be used in conjunction with other types of devices and systems.

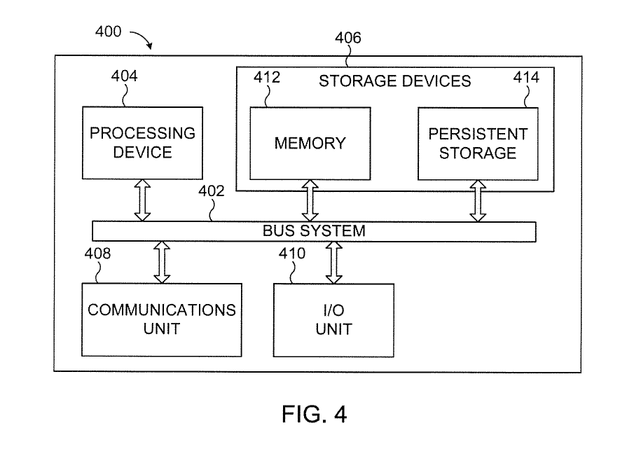

FIG. 4 illustrates an example device 400 for data compatibility across heterogeneous machine architectures according to this disclosure. The device 400 could, for example, represent a computing device in the system 200 of FIG. 2, such as one of the nodes 111-112, 121-122 or the compiler 220. The device 400 could represent any other suitable device for data compatibility across heterogeneous machine architectures.

As shown in FIG. 4, the device 400 can include a bus system 402, which supports communication between at least one processing device 404, at least one storage device 406, at least one communications unit 408, and at least one input/output (I/O) unit 410. The processing device 404 executes instructions that may be loaded into a memory 412. The processing device 404 may include any suitable number(s) and type(s) of processors or other devices in any suitable arrangement. Example types of processing devices 404 include microprocessors, microcontrollers, digital signal processors, field programmable gate arrays, application specific integrated circuits, and discrete circuitry.

The memory 412 and a persistent storage 414 are examples of storage devices 406, which represent any structure(s) capable of storing and facilitating retrieval of information (such as data, program code, and/or other suitable information on a temporary or permanent basis). The memory 412 may represent a random access memory or any other suitable volatile or non-volatile storage device(s). The persistent storage 414 may contain one or more components or devices supporting longer-term storage of data, such as a ready only memory, hard drive, Flash memory, or optical disc. In accordance with this disclosure, the memory 412 and the persistent storage 414 may be configured to store instructions associated with ensuring data compatibility across heterogeneous machine architectures.

The communications unit 408 supports communications with other systems, devices, or networks, such as the networks 110-120. For example, the communications unit 408 could include a network interface that facilitates communications over at least one Ethernet network. The communications unit 408 could also include a wireless transceiver facilitating communications over at least one wireless network. The communications unit 408 may support communications through any suitable physical or wireless communication link(s).

The I/O unit 410 allows for input and output of data. For example, the I/O unit 410 may provide a connection for user input through a keyboard, mouse, keypad, touchscreen, or other suitable input device. The I/O unit 410 may also send output to a display, printer, or other suitable output device.

Although FIG. 4 illustrates one example of a device 400 for data compatibility across heterogeneous machine architectures, various changes may be made to FIG. 4. For example, various components in FIG. 4 could be combined, further subdivided, or omitted and additional components could be added according to particular needs. Also, computing devices can come in a wide variety of configurations, and FIG. 4 does not limit this disclosure to any particular configuration of device.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware or a combination of hardware and software/firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
loading a data element from at least one memory into at least one internal register;
converting the data element from a network standardized format to a device native format;
performing an operation on the data value;
de-converting the data element from the device native format to the network standardized format; and
storing the data element in the at least one memory.

2. The method of claim 1, wherein the performed operation is a fundamental mathematical operation.

3. The method of claim 1, wherein converting the data value comprises at least one of: an endian conversion or a floating point value format conversion.

4. The method of claim 3, wherein:
the network standardized format is one of big-endian or little-endian; and
the device native format is another of big-endian or little-endian.

5. The method of claim 3, wherein:
the network standardized format uses a first floating point value format; and
the device native format uses a different second floating point value format.

6. The method of claim 1, wherein instructions to perform the converting and de-converting are added to machine assembly language code during a compilation of source code of a higher-level programming language.

7. The method of claim 1, wherein the loading, converting, performing, de-converting, and storing operations are performed by a computing device in an industrial process control and automation system, the computing device comprising one of: a general-purpose computer or an industrial process controller.

8. The method of claim 1, wherein the data element comprises at least one of:
a two-byte, four-byte, or eight-byte integer;
a four-byte or eight-byte floating point value; or
a multi-byte string.

9. An apparatus comprising:
at least one memory configured to store a data element; and
at least one processing device configured to:
load the data element from the at least one memory into at least one internal register;
convert the data element from a network standardized format to a device native format;
perform an operation on the data value;
de-convert the data element from the device native format to the network standardized format; and
store the data element in the at least one memory.

10. The apparatus of claim 9, wherein the performed operation is a fundamental mathematical operation.

11. The apparatus of claim 9, wherein the at least one processing device is configured to convert the data value by performing at least one of: an endian conversion or a floating point value format conversion.

12. The apparatus of claim 11, wherein:
the network standardized format is one of big-endian or little-endian; and
the device native format of is another of big-endian or little-endian.

13. The apparatus of claim 11, wherein:
the network standardized format uses a first floating point value format; and
the device native format uses a different second floating point value format.

14. The apparatus of claim 9, wherein instructions for the at least one processing device to perform the converting and de-converting operations are added to machine assembly language code during a compilation of source code of a higher-level programming language.

15. The apparatus of claim 9, wherein the apparatus comprises a computing device in an industrial process control and automation system, the computing device comprising one of: a general-purpose computer or an industrial process controller.

16. A non-transitory computer readable medium containing instructions that, when executed by at least one processing device, cause the at least one processing device to:
load a data element from at least one memory into at least one internal register;
convert the data element from a network standardized format to a device native format;
perform an operation on the data value;
de-convert the data element from the device native format to the network standardized format; and
store the data element in the at least one memory.

17. The non-transitory computer readable medium of claim 16, wherein the performed operation is a fundamental mathematical operation.

18. The non-transitory computer readable medium of claim 16, wherein the instructions that when executed cause the at least one processing device to convert the data value comprise instructions that when executed cause the at least one processing device to perform at least one of: an endian conversion or a floating point value format conversion.

19. The non-transitory computer readable medium of claim 18, wherein:
the network standardized format is one of big-endian or little-endian; and
the device native format of is another of big-endian or little-endian.

20. The non-transitory computer readable medium of claim 18, wherein:
the network standardized format uses a first floating point value format; and
the device native format uses a different second floating point value format.
